(19) United States
(12) Patent Application Publication
(10) Pub. No.: US 2017/0150756 A1
(43) Pub. Date: Jun. 1, 2017

(54) DUAL-ACTIVATION FOR VAPORIZER DEVICES

(71) Applicant: National Concessions Group Inc., Denver, CO (US)

(72) Inventors: Andrew Rexroad, Denver, CO (US); David Ross, Fort Collins, CO (US); Jeremy Heidl, Denver, CO (US); Chris McElvany, Denver, CO (US)

(21) Appl. No.: 15/365,782

(22) Filed: Nov. 30, 2016

Related U.S. Application Data
(60) Provisional application No. 62/260,968, filed on Nov. 30, 2015.

(51) Int. Cl. A24F 47/00; H05B 1/02

(52) U.S. Cl. CPC A24F 47/008; H05B 1/0244; H05B 2203/021

(57) ABSTRACT

An electronic power source for vaporizing inhalants is provided. The device includes a member having a proximal end, a distal end, and a housing extending between the proximal end and the distal end. The device further includes a first electrical contact and a second electrical contact provided at the proximal end and an input receiving device provided at the distal end. Further, a control circuit is provided and is configured to cycle through a plurality of voltage output modes in accordance with input received at the input receiving device, wherein a voltage between the first electrical contact and the second electrical contact is different for at least two of the plurality of voltage output modes.

### FIELD

The present disclosure generally relates to systems and methods for activating a vaporizer device. More specifically, the present disclosure provides unique methods and systems for selecting an output level associated with a power source of a vaporizer device and activating the selected output level.

### BACKGROUND

In recent years, electronic cigarettes and vaporizers have become an increasingly popular alternative to traditional smoking. Among other reasons, vaporizers and electronic cigarettes are perceived as a healthier alternative to traditional smoking because they allow for inhalation of the desirable chemicals without having to inhale the harsh chemicals found in cigarettes and cigarette smoke.

### SUMMARY

It is an object of the present disclosure to provide a vaporizer device capable of supplying a selectable amount of power to a heating element. For example, a voltage output level may first be selected. The vaporizer device may be activated such that the selected voltage output level is provided to the heating element. Such activation may be performed either manually (i.e., push button-activation) or via air flow detection (i.e., puff-activation). In accordance with at least some embodiments, the vaporizer device may include multi-color indicator lights, a stylus tip, a control button, and retention means for a substance to be vaporized.

It is another object of the present disclosure to provide one or more methods for activating a heating element. More specifically, a power source is described that provides one or more user-selectable voltages to a heating element. The activation of such power module may be effected in a plurality of ways. For example, upon selection of a first mode of operation having a first output voltage corresponding to a heating amount, the power source may be activated upon airflow detection. Alternatively, or in addition, upon a selection of a second mode of operation, the power source may be activated when an activation button is engaged.

In accordance with at least one embodiment of the present disclosure, a vaporizer device is provided having a control button located on the device, for example on one end (first end). The device may further include a plurality of indicator lights. Such a device may be activated by clicking the button a predetermined number of times, for example five times, which may be reset to a different number. Once activated, the device may be cycled through various modes providing various output voltages in accordance with a predetermined number of button clicks for one or more predetermined amounts of time, for example by double clicking the button. The modes may include 2.4 V output/8 second timeout, 3.2 V output/8 second timeout, 4.0 V (max output)/8 second timeout, and 4.2 V (max output)/12 second timeout (WAX MODE), although these quantities associated with voltages and/or timeouts may vary. Each mode may also be assigned or utilize a different color, which may be displayed by one or more indicator lights when such mode is activated. As a non-limiting example, the following colors correspond to the above-referenced modes: purple (2.4 V/8 s), orange (3.2 V/6s), green (4.0 V/4 s), and blue (4.0 V/12 s). Of course, different colors and combinations may be utilized.

In another embodiment, the button may also include a battery indicator option activated by a predetermined number of button clicks, for example triple clicking the button. For example, the indicator lights may display a color corresponding to an amount of charge remaining in the device battery. As one non-limiting example, a green output may represent that eighty percent or more of the battery charge is left. An orange output may indicate that between forty and sixty percent of the battery charge is left. In other embodiments, once clicked, the indicator lights will display every color starting with red and ending at the current charge level. Further, while charging, the indicator lights may pulse the color of the current charge level; the color may change as the device charges. Alternatively, or in addition, the rate or sequence of the pulsing may change in accordance with a charge level for example.

In yet another embodiment, one end of the vaporizer or the control button may further serve as a stylus. The stylus may be adapted to work with resistive, capacitive, or surface acoustic wave (SAW) displays. For example, styluses described in U.S. Pat. No. 8,928,635 and U.S. Pat. No. 8,493,359, herein incorporated by reference in their entirety, and other styluses may be utilized in the vaporizer device.

In yet another embodiment, an electronic vaporizer device for vaporizing inhalants is described. In such an embodiment, the electronic vaporizer device may include a member or body comprising a proximal end, a distal end, and a housing extending between the proximal end and the distal end; a first electrical contact and a second electrical contact provided at the proximal end; an input receiving device provided at the distal end; and a control circuit configured to cycle through a plurality of voltage output modes in accordance with input received at the input receiving device, wherein a voltage between the first electrical contact and the second electrical contact is different for at least two of the plurality of voltage output modes. The housing need not be cylindrical in cross-section but may comprises a wide variety of cross-sectional shapes. The electronic vaporizer device may include a sensor configured to activate a first voltage output mode; and an activation button configured to activate a second voltage output mode, wherein the activation button does not activate the first voltage output mode or other mode. Accordingly, the displayed output mode may be changed, for example by activation of the activation button. Further still, the electronic device may include a second member including at least one of an atomizer, cartomizer, or clearomizer, wherein the at least one atomizer, cartomizer, or clearomizer includes a heating element and the activation button. The electronic device may also include at least one status indicator configured to provide an indication based on a voltage output mode.

### BRIEF DESCRIPTION OF THE DRAWINGS

The accompanying drawings, which are incorporated in and constitute a part of the specification, illustrate embodiments of the disclosed system and, together with the general description of the disclosure given above and the detailed description of the drawings given below, serve to explain the principles of the disclosure.

FIG. 1 illustrates an exploded view of a portion of an electronic vaporizer device in accordance with embodiments of the present disclosure;

FIG. 2A depicts a side view of the vaporizer device of FIG. 1;

FIG. 2B depicts a section view of the vaporizer device depicted in FIG. 2A;

FIG. 3 is a first block diagram of an electronic vaporizer device in accordance with embodiments of the present disclosure;

FIG. 4 is a first flow chart in accordance with embodiments of the present disclosure;

FIG. 5 is a state diagram depicting an operation of an electronic vaporizer device in accordance with embodiments of the present disclosure;

FIG. 6 is a second flow chart in accordance with embodiments of the present disclosure; and

FIG. 7 is a second block diagram of an electronic vaporizer device in accordance with embodiments of the present disclosure.

In certain instances, details that are not necessary for an understanding of the disclosure or that render other details difficult to perceive may have been omitted. It should be understood, of course, that the disclosure is not necessarily limited to the particular system embodiments illustrated herein.

### DETAILED DESCRIPTION

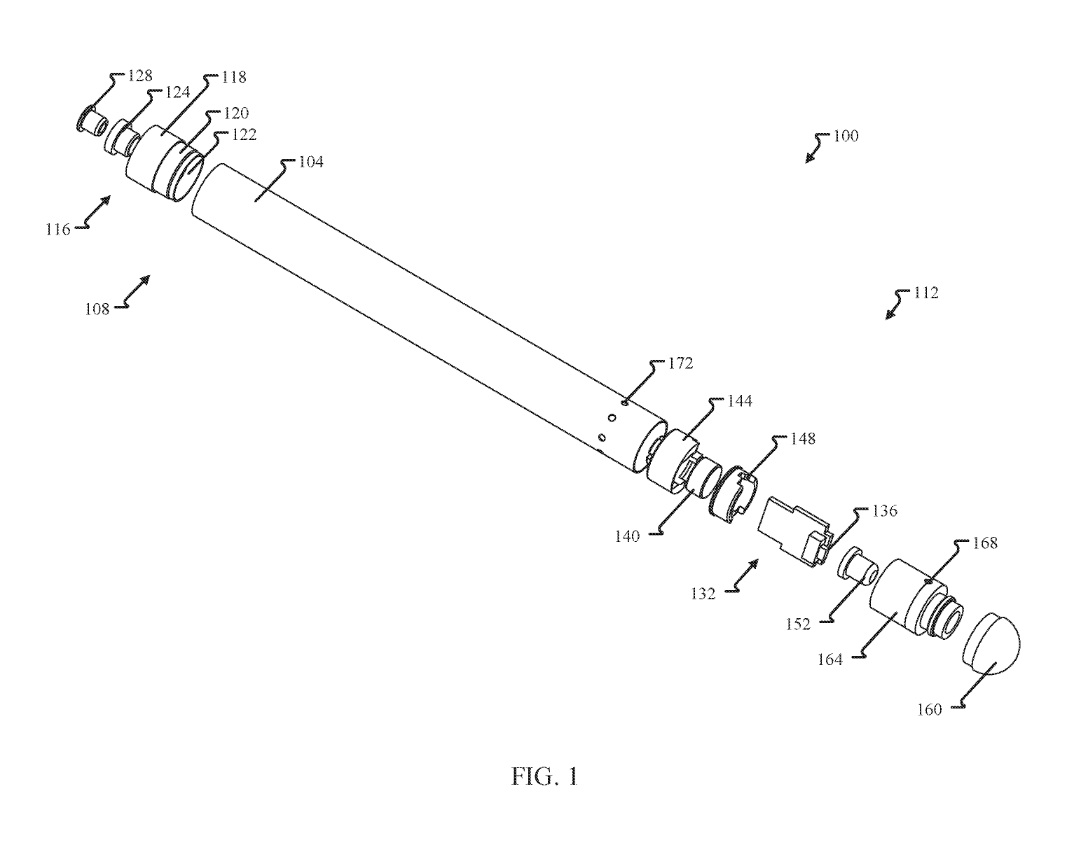

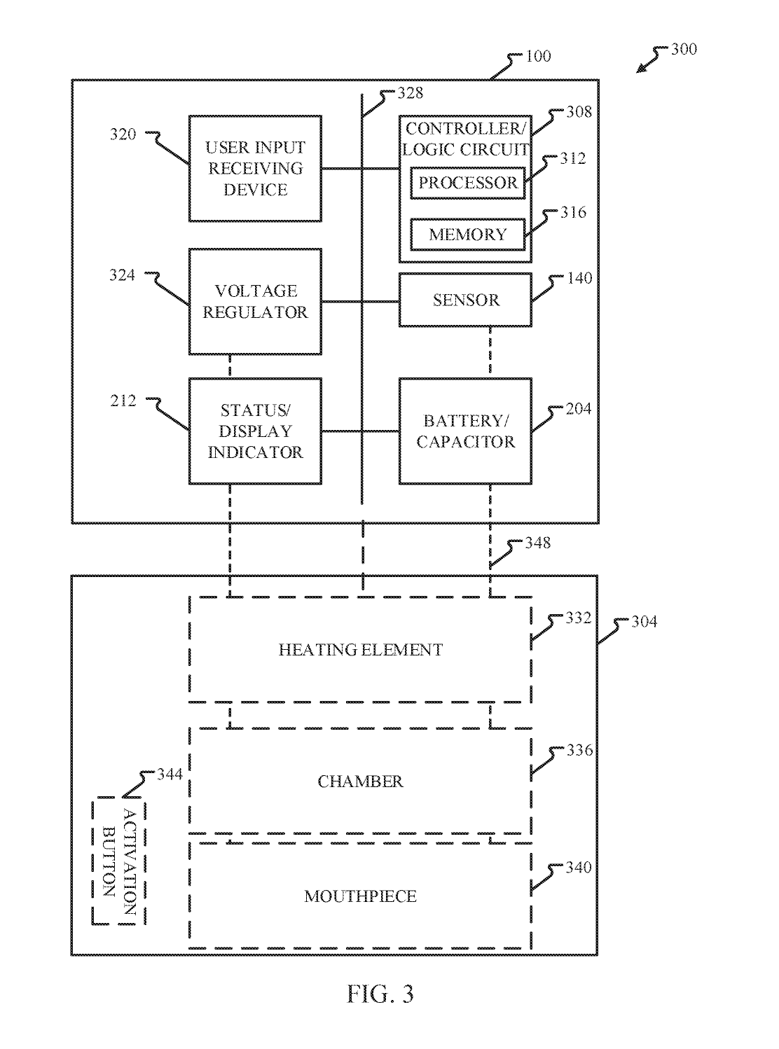

Referring initially to FIG. 1, an exploded view of a first portion 100 of a vaporizer pen is illustrated in accordance with at least one embodiment of the present disclosure. The portion may also be referred to as a power module, a battery, and/or a power source. The power source 100 is generally adapted to be engaged with or otherwise connected to a second portion of the vaporizer pen that includes a vaporizing assembly (see e.g., FIG. 3). The vaporizing assembly generally includes one or more heating elements and one or more chambers containing a substance to be vaporized. Such vaporizing assembly may also be referred to as and/or operate as an atomizer, cartomizer, and/or clearomizer. The heating element generally heats the substance to be vaporized to a temperature of vaporization. The voltage and/or current provided by the power source 100 to the heating element of the vaporizing assembly may influence quantity and quality of a produced vapor. The length of time or duration of the applied voltage or current may also influence the quality and quantity of a produced vapor. Moreover, an amount of heat supplied by the heating element may differ based on a substance to be vaporized. That is, differing substances to be vaporized may require differing levels and/or durations of heating to achieve optimal and/or preferred vaporization. Accordingly, the power source 100 may be operable to control an amount of heat and/or a heating duration provided by the heating element by altering a voltage and/or current provided to the heating element.

In accordance with embodiments of the present disclosure, the power source 100 generally includes a housing 104 having a proximal end 108 and a distal end 112 opposite to the proximal end 108. In a preferred embodiment, the housing may be cylindrical in cross-section or may have a different cross-sectional shape, including, for example, oval, triangular, hexagonal, pentagonal, octagonal, etc. The proximal end 108 generally includes one or more vaporizing assembly interface sections 116 configured to be attached to or otherwise engaged with a vaporizing assembly. The distal end 112 generally includes control electronics configured to provide, or make available, one or more selectable voltages to the vaporizing assembly via the proximal end 108. The housing 104 generally includes one or more batteries and/or capacitors that store an amount of charge and transfer such charge to the vaporizing assembly at the direction of the control electronics in the distal end 112.

In accordance with embodiments of the present disclosure, the vaporizing assembly interface section 116 may include a proximal end 118 and a distal end 120, where the distal end is configured to mate with or otherwise engagement with the housing 104. The proximal end 118 and the distal end 120 may have the same or different cross-sectional shapes. As illustrated, the two end portions 118 and 120 each have a cylindrical cross-section with the distal end cross-section being slightly smaller in diameter. In one embodiment, the distal end 120 of the power source 100 is configured to mate with or otherwise engage with the housing 104. The distal end 120 may frictionally engage the housing or may further include a threaded section at one end thereof that is configured to engage with the housing. Moreover, an inner portion 122 of the distal end 120 may be electrically coupled to a first lead of a battery contained within the housing 104. The vaporizing assembly interface section 116 further includes a first insulator 124 that insulates a first electrical contact 128, also known as a center post, from the distal end 120. The first electrical contact 128 may be electrically coupled to a second lead of the battery contained within the housing 104.

In accordance with embodiments of the present disclosure, the distal end 112 generally includes control electronics for regulating and/or supplying a selectable amount of voltage and/or current for a selectable duration of time to the vaporizing assembly via the vaporizing assembly interface section 116 of the proximal end 108. That is, upon activation, a selectable voltage, also referred to as a potential, may be provided between the first electrical contact 128 and an inner section 122 of the distal end 120 of the interface section 116. The control electronics generally include components necessary to regulate an amount of voltage and/or current provided by the battery in accordance with a user-selected value and/or a user-selected duration. That is, a user may first set a desired voltage level of the power source 100 such that upon activation, an output of the desired voltage level is provided. Alternatively, the power source 100 may come preprogrammed with default settings that may be altered, configured, and/or reset to different levels. Moreover, the control electronics provide the necessary components to activate such voltage. Accordingly, a voltage and/or duration may be selected; however, the activation of such may be dependent upon a separate activation condition, such as a detection of airflow by one or more sensors and/or an engagement of an activation button. In accordance with at least one embodiment of the present disclosure, the distal end 112 includes a printed circuit board (PCB) assembly 132 capable of receiving input via a switch 136 and based on such input, regulate a voltage provided between the first electrical contact 128 and the inner section of the interface section 116. Moreover, the PCB assembly 132 may be communicatively coupled to the sensor 140 such that when the sensor 140 detects air flow and activates the power source 100, the sensor 140 completes a circuit between one or more of the first electrical contact 128 and/or inner section of the interface section 116, and/or directs the PCB assembly 132 to provide the user-selected voltage to the vaporizing assembly interface section 116. The sensor 140 may be a microphone capable of detecting airflow movement. Alternatively, or in addition, the sensor 140 may be a pressure transducer capable of detecting a pressure drop created by inhalation of a user. The sensor 140 may be contained in a sensor housing 144; the PCB assembly 132, switch 136, and switch spacer 152 may be provided in the PCB and switch housing 164 with a spacing ring 148 separating the sensor housing 144 and the PCB and switch housing 164. The PCB assembly 132 may include a plurality of status indicators, such as multicolor light emitting diodes (LEDs), configured to provide a visual indication of a user-selected voltage and/or duration, battery level, and/or status as to when the power source 100 is activated by outputting a certain color. Accordingly, the one or more status indicators are configured to provide such status indication through the status indicator apertures 168 of the PCB and switch housing 164 and the status indicator apertures 172 of the housing 104. Alternatively, the LEDs may be positioned at other locations along the length and perimeter of the power source 100 or at locations on the vaporizer device utilized in combination with the power source 100. A tip 160 may cover the PCB and switching housing in a manner such that a depression of the tip 160 moves the switch spacer 152 thereby activating the switch 136 and providing user input to the PCB assembly 132. In accordance with at least some embodiments of the present disclosure, the tip 160 may also act as a stylus for providing input to a touch screen device.

In accordance with at least some embodiments of the present disclosure, the PCB assembly 132 may include one or more printed circuit boards containing necessary logic components to receive input, select a voltage and/or current level and/or duration, and electrically couple the battery of the of the power source 100 to the vaporizer assembly interface section 116 such that a desired voltage is provided to the vaporizer assembly. Accordingly, the PCB assembly 132 may include one or more processors and/or logic components such as flip flops, AND, OR, NAND, NOR, and XOR components, to effectuate a voltage selection. Alternatively, or in addition, the PCB assembly 132 may include one or more field programmable gate arrays (FPGA) and/or one or more clocks. Alternatively, or in addition, the PCB assembly 132 may include one or more timers and one or more capacitive and resistive circuits to effectuate a voltage selection. Moreover, and as previously discussed, the PCB assembly 132 may include one or more status indicators that indicate at least one of a battery level, a vaporization level (such as a voltage level), and/or activation of the power source 100.

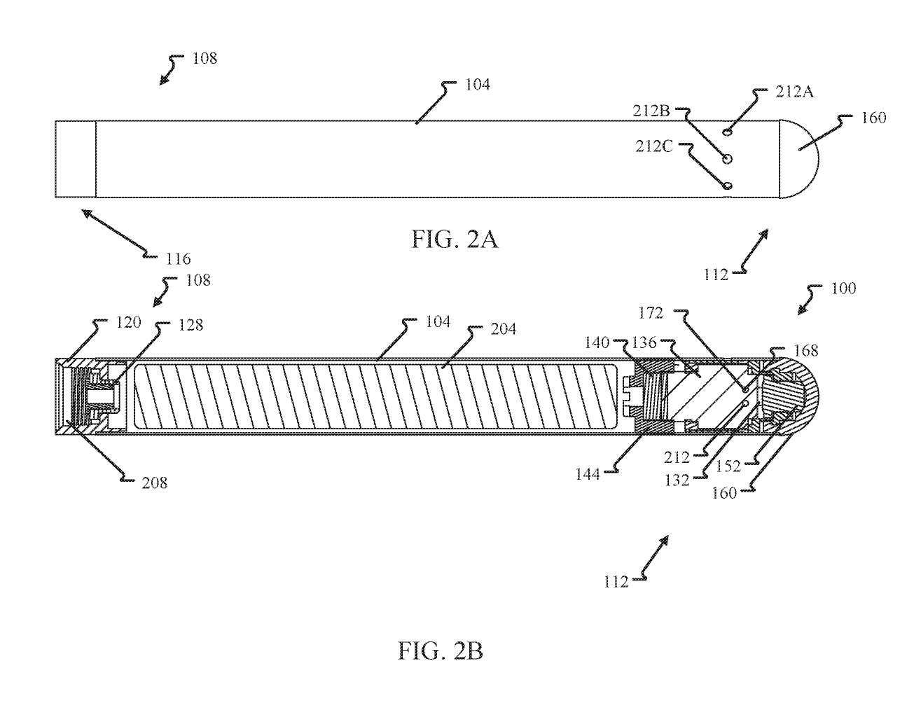

Referring now to FIGS. 2A-2B, a side view and a section view of the power source 100 are illustrated in accordance with at least one embodiment of the present disclosure. Various features as shown and described with respect to FIG. 1 are provided in FIGS. 2A-2B. FIG. 2A generally illustrates an outer view of the power source 100. At the distal end 112, one or more status indicators 212A-C are illustrated. The one or more status indicators 212A-C are provided such that upon illumination, light from the one or more status indicators 212A-C is directed out of the one or more status indicator apertures 172 of the housing 104. Further, as illustrated in FIG. 2B, the battery/capacitor 204 may be contained within the housing 104. The battery/capacitor 204 may comprise any power source capable of providing a voltage and current. As one example, the battery/capacitor 204 may be a 280 mAh rechargeable lithium-ion battery capable of providing 4.0 volts. Additionally, FIG. 2B illustrates an inner section 208 of the proximal end 118 of the interface section 116 that connects with or otherwise engages with a vaporizing assembly. FIG. 2B further illustrates the PCB assembly 132 which may include one or more components, to cause a user-selected voltage to be output to the vaporizer assembly interface section 116.

FIG. 3 illustrates a block diagram of a vaporizing pen 300 including a power source 100 and vaporizer assembly 304 in accordance with embodiments of the present disclosure. In one embodiment, the power source 100 generally includes a sensor 140, a battery/capacitor 204, a status/display indicator 212, a controller/logic circuit 308, a voltage regulator 324, an input receiving device 320, and a communication bus 328. The vaporizer assembly 304 generally includes a heating element 332, a chamber for containing a substance to be vaporized 336, and a mouthpiece 340. The substance to be vaporized may be in the form of a liquid, gelatin, frozen, or solid solution. The substance to be vaporized may be configured to deliver a particular substance in vaporized form to a user when the substance to be vaporized changes state to a gaseous substance. For example, when an appropriate and/or user-selectable amount of heat is provided by the heating element 332 for a selected duration of time, the substance to be vaporized may change from one state to a gaseous or vapor state. Such substance may include nicotine, THC, other compounds, and/or any combinations or derivative thereof.

Some substances to be vaporized may require a greater amount of heat than other substances in order to change state. In accordance with embodiments of the present disclosure, a voltage provided to the heating element may change and/or be selected depending on the substance to be vaporized. That is, because an amount of heat generated by the heating element 332 is based on an amount of voltage provided to the heating element 332, a higher voltage generally generates a greater amount of heat. Moreover, the length of time, or duration in which heat is applied to the substance to be vaporized, may impact the change of state of the substance. For example, it may take longer to vaporize a substance when applying a reduced amount of heat, or low voltage, than when applying an increased amount of heat, or higher voltage. Moreover, such amount of heat and duration may depend on user preferences. That is, some users may enjoy a vaporized substance more when an amount of heat and duration are different from the preferences of other users. Thus, embodiments of the present disclosure allow variation or alteration of the amount and duration of heat applied. In accordance with embodiments of the present disclosure, the power source 100 provides a user the ability to selectively provide a plurality of differing voltage levels to the heating element 332. Accordingly, a plurality of differing amounts of heat may be generated by the heating element 332 and applied to the substance to be vaporized within the chamber 336.

The vaporizing assembly 304 may be coupled to the power source 100 such that a common air passage way 348 is created between and within the assembled vaporizing pen 300 to include at least the sensor 140, chamber 336, and mouthpiece 340. Accordingly, a user may select a voltage level in accordance with a desired heating level provided by the heating device and inhale utilizing the mouthpiece 340. In some embodiments, the act of inhaling will cause air to move within the common passageway, which may be detected by the sensor 140. Alternatively, or in addition, the act of inhaling will cause a pressure drop within the common passageway 348 which may be detected by the sensor 140. Further still, in some embodiments, there may be multiple passage ways as long as the sensor 140 can detect a pressure change or air movement and the user can inhale vapor from the chamber 336. Accordingly, when air movement and/or a pressure drop is detected, the controller/logic circuit 308 may cause a voltage to be provided to the heating element 332; such voltage may be in accordance with a user-selectable voltage and/or duration. Alternatively, or in addition, voltage and/or heating duration can be preset by the manufacturer and also configurable by the user.

Alternatively, or in addition, the vaporizing assembly 304 may include an activation button 344 for use with one or more specified substances to be vaporized and at a predetermined output level. For example, where the substance to be vaporized is in more of a solid form, such as a wax, the power source 100 may provide a voltage to the heating element 332 and bypass the sensor 140. For example, a user may select a voltage level in accordance with a desired amount of heat for use with a wax substance to be vaporized. Accordingly, a user may utilize activation button 344 to complete a circuit to activate the heating element 332, bypassing the sensor 140. When the user no longer engages the activation button 344, the heating element 332 may cease to function and/or may cease to function after a certain period of time. Alternatively, pressing the button 344 a predetermined or preset number of times may activate the heating element 332, which will remain on until deactivated by pressing the button 344 a predetermined or preset number of times.

The controller/logic circuit 308 may include a processor 312 and memory 316. The processor 312 may be provided to execute instructions contained within memory 316 and/or reference data within the memory 316. Accordingly, the processor 312 may be implemented as any suitable type of microprocessor or similar type of processing chip, such as any general-purpose programmable processor, digital signal processor (DSP), or controller for executing application programming contained within memory 316. Alternatively, or in addition, the processor 312 and memory 316 may be replaced or augmented with an application specific integrated circuit (ASIC), a programmable logic device (PLD), and/or a field programmable gate array (FPGA). Alternatively, or in addition, the controller/logic controller 308 may include one or more processors and/or logic components such as, but not limited to, flip flops, AND, OR, NAND, NOR, and XOR components. Alternatively, or in addition, the controller/logic circuit 308 may include one or more timers and one or more capacitive and resistive circuits.

The memory 316 generally comprises software routines facilitating, in operation, pre-determined functionality of the controller/logic circuit 308. The memory 316 may be implemented using various types of electronic memory generally including at least one array of non-volatile memory cells (e.g., Erasable Programmable Read Only Memory (EPROM) cells or FLASH memory cells, etc.). The memory 316 may also include at least one array of dynamic random access memory (DRAM) cells. The content of the DRAM cells may be pre-programmed and write-protected thereafter, whereas other portions of the memory 316 may be selectively modified or erased. The memory 316 may be used for either permanent data storage or temporary data storage. For example, the memory 316 may record at least one of a previous state, current state, and/or future state. The controller/logic circuit 308 and/or the voltage regulator 324 may be provided on the PCB assembly 132.

The user input receiving device 320 may be the same as or similar to the switch 136 and generally provides an interface to adjust a state, mode, and/or level of output associated with the power source 100. That is, a user may toggle the voltage level to be provided to the heating element 332 by depressing or otherwise engaging the user input receiving device 320. For example, the controller/logic circuit 308 may count or otherwise detect a number of times the switch 136 has been engaged within a certain period of time. For example, two clicks of the switch 136 may cause the power source 100 to cycle output modes and cause the voltage provided by the voltage regulator 324 to the heating element 332 to change. In some embodiments, changing the output mode will automatically cause the status/display indicator 212 to output a color of light in accordance with the current output mode. Alternatively, the light output by the status/display indicator 212 may be manually changed to any desired output. Alternatively, or in addition, three clicks of the switch 136 may cause the status/display indicators 212 to output a color indicative of a charge of the battery/capacitor 204; and five clicks of the switch 136 within a five second period may cause the power source 100 to turn on/off. Alternatively, or in addition, the controller/logic circuit 308 may detect a sequence associated with the user input receiving device 320 and toggle output modes, device operation, and/or indicate a charge of the battery/capacitor 204 in accordance with the detected sequence. It should be appreciated that the number of switch activations or toggles are not limited to the examples provided herein, but may vary from those exemplary embodiments described herein. Table 1 below illustrates a plurality of exemplary modes of operation, which may be toggled in accordance with the input received at the user input receiving device 320. For example, as illustrated in Table 1, each detected double-click of the user input receiving device 320 may toggle the current output mode to the next output mode. Of course, the values in Table 1 are illustrative of non-limiting example output modes, colors, and durations. Other output modes, colors, durations, and combinations thereof are contemplated. Moreover, in one or more output modes, the microphone may be bypassed and activation of the heating element may require engagement of the activation button 344.

TABLE 1

| Status/Display | Output | |
|---|---|---|
| Indicator Color | Voltage | Duration |
| Purple | 2.4 V | 8 Seconds |
| Orange | 3.2 V | 8 Seconds |
| Green | 4.0 V | 8 Seconds |
| Blue | 4.0 V | 12 Seconds |

Table 2 below illustrates a plurality of colors that may be displayed based on a current charge of the battery/capacitor 204. For example, as illustrated in Table 2, when a three click sequence is detected, the status/display indicator 212 may output a green light in accordance with a battery that has a charge of eighty percent or higher. Of course, the values in Table 2 are illustrative of non-limiting example colors and associated battery/capacitor charge levels. Other colors and associated battery/capacitor charge levels and combinations thereof are contemplated.

TABLE 2

| Status/Display | |
|---|---|
| Indicator Color | Meaning |
| Green | 80%+ battery charge |
| Yellow | 60%-80% battery charge |
| Orange | 40%-60% battery charge |
| Red | 20%-40% battery charge |
| Flashing Red | Under 20% battery charge |

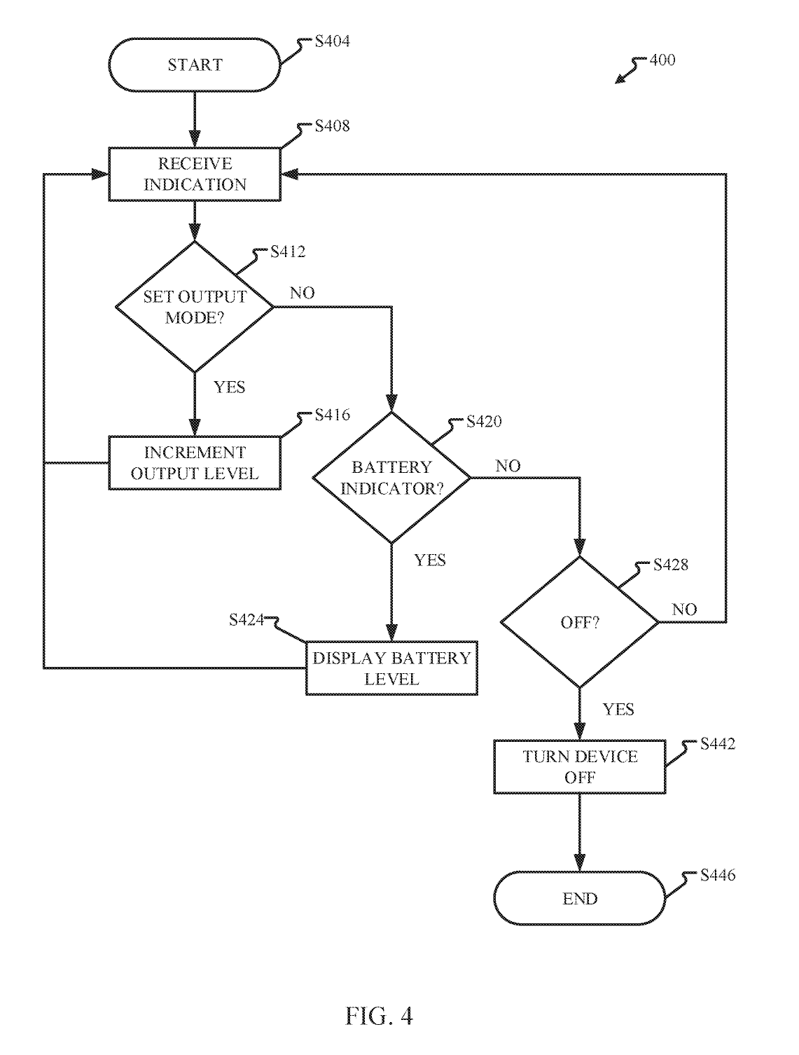

Referring now to FIG. 4, a method 400 for cycling an output mode of the power source 100, displaying a battery/capacitor level of the battery/capacitor 204, and/or turning on and off the power source 100 is provided in accordance with embodiments of the present disclosure. Method 400 is in embodiments performed by one or more devices, such as the one or more devices included in the power source 100 and/or the vapor assembly 304. More specifically, one or more hardware and software components including the controller/logic circuit 308 may be involved in performing the method 400. In one embodiment, one or more of the previously described devices perform one or more of the steps of method 400. The method 400 may be executed as a set of processor-executable instructions, executed by the controller/logic circuit 308 and encoded or stored on a computer-readable medium, such as memory 316. Hereinafter, the method 400 shall be explained with reference to systems, components, modules, etc. described with reference to FIGS. 1-3.

Method 400 may continuously flow in a loop, flow according to a timed event, or flow according to a change in an operating or status parameter. Method 400 is initiated at step S404 where a user input via the user input receiving device 320 is received. For example, a user may depress the switch 136 a number of times within a predetermined duration of time; such depressions or clicks may be detected or recieved at the controller/logic circuit 308 at step S408.

Based on the number of clicks, for example the number of clicks in a sequence, the controller/logic circuit 308 may determine that the output mode, or voltage, should change at step S412 and increment the voltage to the next level at step S416. For example, the controller/logic circuit 308 may cause the power source 100 to move from a state of outputting 2.4 V for a duration of 8 seconds to a state of outputting 4.0 V for a duration of 8 seconds. Once the output level has been adjusted, the status/display indicators 212 may output a color indicative of the current output mode. The method 400 may return to step S408.

Alternatively, or in addition, where the input receiving device 320 receives a different sequence, for example three clicks within a certain period of time, the controller/logic circuit 308 may determine that the battery/capacitor level should be displayed via the status/display indicators 212 at step S420. That is, the controller/logic circuit 308 may determine a corresponding charge of the battery/capacitor 204, determine the appropriate color of light to output, and cause the status/display indicators 212 to output the determined color of light at step S424. Method 400 may return to step S408.

Alternatively, or in addition, where the input receiving device 320 receives another sequence, for example five clicks within a certain period of time, the controller/logic circuit 308 may determine, at step S428, that the power source 100 should be toggled off, for example at step S442. Accordingly, the power source 100 may toggle off at step S442 and method 400 may end at step S446.

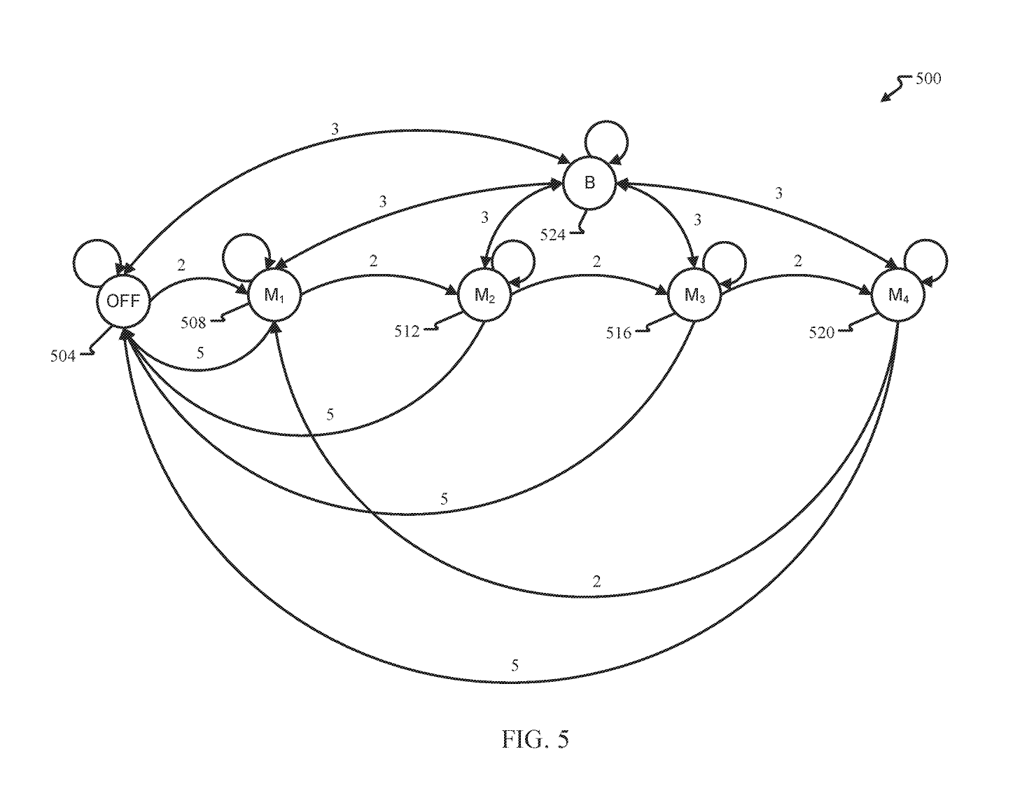

FIG. 5 generally illustrates a state diagram 500 for toggling a voltage output mode, displaying a battery/capacitor charge level, and/or toggling the power source 100 on/off in accordance with embodiments of the present disclosure. For example, the state diagram 500 may include an off state 504, a first output mode state 508, a second output mode state 512, a third output mode state 516, a fourth output mode state 520, and a battery/capacitor state 524. As depicted in the state diagram 500, transitions from one state to another state depend on an indication received at the user input receiving device 320. The number associated with the arrows interconnecting the various states are representations of exemplary numbers of toggles of the user input receiving device 320 and may vary. For example, the power source 100 may be in state 504 when the user input receiving device 320 receives two clicks for example. Upon receiving two clicks, the controller/logic circuit 308 may cause the power source 100 to transition from an off state 504 to a first state 508 where a first voltage level and/or duration is set and a corresponding color of light is output from the status/display indicators 212. If for example, the user input receiving device 320 receives two additional clicks for example, the controller/logic controller 308 may cause the power source 100 to transition from a first state 508 to a second state 512 where a second voltage level and/or duration is set and a corresponding color of light is output from the status/display indicators 212.

Alternatively, or in addition, if the user input receiving device 320 receives three additional clicks for example, the controller/logic controller 308 may cause the power source 100 to transition from a second state 512 to the battery/capacitor state 524 where a corresponding color of light is output from the status/display indicators 212. The power source 100 may then automatically transition back to the prior state of 512. If the user input receiving device 320 receives five additional clicks for example, the controller/logic controller 308 may cause the power source 100 to transition from a second state 512 to the off state 504. As previously mentioned, the sensor 140 may be deactivated in one or more of the states. For example, as depicted in Table 1, a state where the output voltage is 4.0 V and the duration is 12 seconds may correspond to a state where the sensor 140 is deactivated, thereby requiring that power source 100 be activated using the activation button 344 for example. Each state may also return back to itself if the user input receiving device receives an indication not defined or otherwise implemented for each state. For example, the controller/logic circuit 308 may determine that one click does not correspond to a defined state; accordingly, the current state may not change.

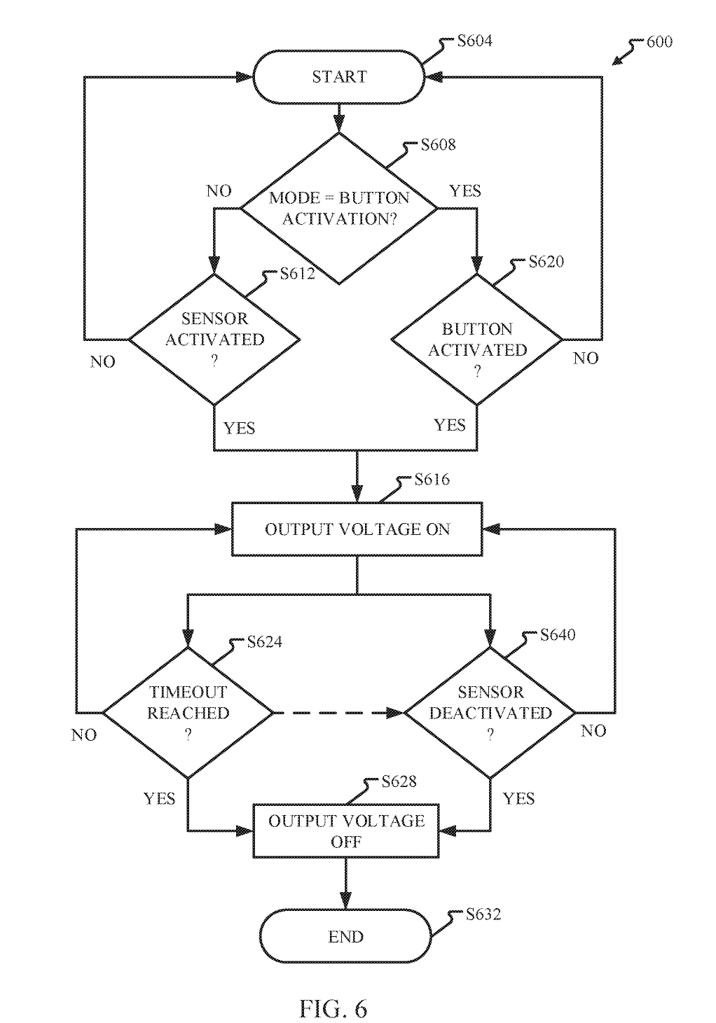

Referring now to FIG. 6, a method 600 for outputting a voltage to a heating element, such as heating element 332, is described in accordance with embodiments of the present disclosure. Method 600 is in embodiments performed by one or more devices, such as the one or more devices included in the power source 100 and/or the vapor assembly 304. More specifically, one or more hardware and software components including the controller/logic circuit 308 may be involved in performing the method 600. In one embodiment, one or more of the previously described devices perform one or more of the steps of method 600. The method 600 may be executed as a set of processor-executable instructions, executed by the controller/logic circuit 308, and encoded or stored on a computer-readable medium, such as memory 316. Hereinafter, the method 600 shall be explained with reference to systems, components, modules, etc. described with reference to FIGS. 1-5.

Method 600 may continuously flow in a loop, flow according to a timed event, or flow according to a change in an operating or status parameter. Method 600 is initiated at step S604 and transitions to step S608 where, based on the current mode, the controller/logic circuit 308 determines if the mode of activation is based on the activation button 344 or the sensor 140. If the mode of activation requires the sensor to be activated, such as at step S612, then at step S612 the method 600 determines if the sensor, such as sensor 140, has been activated. If the sensor 140 has been activated, then method 600 proceeds to step S616 where a voltage is applied to the vaporizing assembly interface 116 thereby electrically coupling the battery 204 of the power source 100 to the heating element 332. Accordingly, at step S616, a voltage in accordance with the current mode may be applied to the heating element 332 and the heating element 332 may be turned on at step S616. Alternatively, or in addition, the current mode may require button activation; that is, at step S608, the controller/logic circuit 308 may determine that the current mode bypasses the sensor 140 and instead relies upon the activation button 344. Accordingly, the method 600 applies a voltage to the vaporizing assembly interface 116 thereby electrically coupling the battery 204 of the power source to the activation button 344 and the heating element 332. Accordingly, at step S620, if it is determined that the activation button 344 has been engaged, a voltage in accordance with the current mode may be applied to the heating element 332 and the heating element 332 may be turned on at step S616.

Voltage may be applied to the vaporizer assembly interface 116 for a predetermined period of time. Accordingly, if after activation the controller/logic circuit 308 determines that a timeout has been reached at step S624, the controller/logic circuit 308 deactivates and ceases to provide voltage to the vaporizer assembly interface 116 at step S628. For example, if the selected/current mode indicates that the heating element 332 should be active for 6 seconds, the controller/logic controller 308 will stop providing voltage to the vaporizer assembly interface 116 once a duration of six seconds has been met. Alternatively, or in addition, the voltage may be applied to the vaporizer assembly interface 116 as long as the sensor, such as sensor 140, is active. For example, at step S640, if the sensor 140 has been deactivated, (that is, no inhalation is occurring), method 600 may proceed to step S628 where the controller/logic controller 308 ceases providing voltage to the voltage assembly interface 116. Alternatively, or in addition, either reaching the timeout at step S624 and/or the deactivation of the sensor at step S640 may deactivate the voltage at the vaporizer assembly interface 116. Method 600 may then end at step S632.

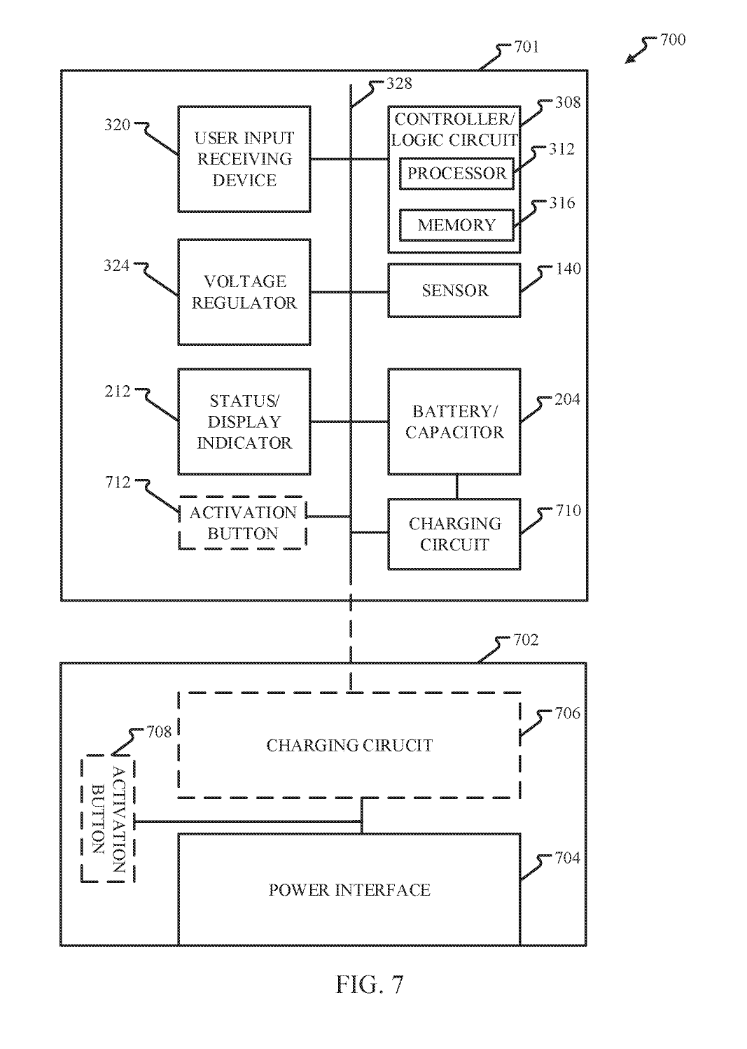

FIG. 7 illustrates a block diagram of a vaporizing pen 700 including a power source 701 and a power source charger 702 in accordance with embodiments of the present disclosure. More specifically, the power source 701 may be configured to mate with or otherwise engage with the power source charger 702 such that the power source charger 702 provides a battery/capacitor charging capability. That is, the power source charger 702 may include a power interface 704 coupled to a charging circuit 706. The power interface 704 may be any power interface capable of being electrically coupled to one or more sources of power. Non-limiting power interfaces 704 may include USB®, mini USB®, Apple's lighting connector, and wireless power transfer. Of course, one or more transformers may reside between the power interface 704 and a source of power, such as a 120 outlet; in other instances, the power interface 704 may be directly connected to such a power source. For example, if the power interface 704 is powered via USB®, the power interface 704, and thus the power source charger 702, may be directly connected to a female USB port. In some instances, the power source charge 702 may be connected to a charging circuit 706; the charging circuit may include necessary circuitry to condition a voltage and/or current prior to charging a battery/capacitor 704. Moreover, an activation button 708 may activate the charging circuit 706 such that the power source charger 702 initiates charging at such activation.

The power source 701 may engage with the power source charger 702 via the vaporizing assembly interface section 116. That is, in one embodiment, the distal end 120 may frictionally engage the power source charger 702 or may further include a threaded section at one end thereof that is configured to engage with the power source charger 702. Moreover, an inner portion 122 of the distal end 120 may be electrically coupled to a first lead of a battery contained within the housing 104. Thus, the vaporizing assembly interface section 116 further includes a first insulator 124 that insulates a first electrical contact 128, also known as a center post, from the distal end 120. The first electrical contact 128 may be electrically coupled to a second lead of the battery contained within the housing 104. Accordingly, a first portion of the power source charger 702 may engage with the first electrical contact 128 while a second portion of the power source charger 702 may engage with a second electrical contact (e.g. non-center post contact).

The power source charger 702 may include a charging circuit 710. The charging circuit 710 may be the same as the charging circuit 706 previously described. However, in embodiments, only one of the charging circuits 706 or 710 are utilized. In some embodiments, both the charging circuit 706 and the charging circuit 716 may be utilized. As the battery/capacitor 204 is charged, the charging operation and/or an indication as to an amount of charge in the battery may be displayed at the status/display indictor 212. The power source 701 may include the activation button 712 for activating the charging operation as previously described with respect to activation button 708. In some embodiments, activation of the charging operation may utilize an activation button 708 and/or 712 and may be activated utilizing capacitive sensing capability. For instance, a user may simply swipe a finger over either of the activation buttons 708/712 to initiate the charging process.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having,” and variations thereof herein are meant to encompass the items listed thereafter and equivalents thereof, as well as, additional items.

What is claimed is:

1. An electronic power supply for vaporizing inhalants, the power supply comprising:
a member including a proximal end, a distal end, and a housing extending between the proximal end and the distal end;
a first electrical contact and a second electrical contact provided at the proximal end;
an input receiving device provided at the distal end; and
a control circuit configured to output one of a plurality of output modes in accordance with input received at the input receiving device, wherein a voltage between the first electrical contact and the second electrical contact is different for at least two output modes of the plurality of output modes.

2. The electronic power supply of claim 1, further comprising:
a sensor configured to activate a first output mode; and
an activation button configured to activate a second output mode, wherein the activation button does not activate the first output mode.

3. The electronic power supply of claim 2, wherein the sensor is at least one of a pressure transducer that detects a pressure drop or a microphone that detects a movement of air.

4. The electronic power supply of claim 2, further comprising:
a second member including at least one of an atomizer, cartomizer, or clearomizer, wherein the at least one atomizer, cartomizer, or clearomizer includes a heating element and the activation button.

5. The electronic power supply of claim 1, wherein a duration of time in which the voltage output between the first electrical contact and the second electrical contact is different for at least two output modes of the plurality of output modes.

6. The electronic power supply of claim 1, further comprising:
at least one status indicator configured to provide an indication based on the output mode.

7. The electronic power supply of claim 1, wherein the at least one status indicator is configured to provide an indication based on an amount of charge in a battery disposed within the housing.

8. The electronic power supply of claim 1, further comprising:
a stylus tip covering the input receiving device provided at the distal end, wherein the stylus tip is configured to work with at least one of a resistive, capacitive, or surface acoustic wave (SAW) display.

9. The electronic power supply of claim 1, wherein the control circuit is configured to sequentially cycle through the plurality of output modes in accordance with the input received at the input receiving device.

10. A method for activating an electronic vaporizer device for vaporizing inhalants, the method comprising:
receiving a first input from an input receiving device of the electronic vaporizer device;
determining a first output mode of a plurality of output modes based on the first input, wherein a voltage between a first electrical contact and a second electrical contact is different for at least two output modes of the plurality of output modes; and
providing a first voltage between the first electrical contact and the second electrical contact of the electronic vaporizer device, wherein the first voltage is based on the first output mode.

11. The method for activating the electronic vaporizer device according to claim 10, further comprising:
receiving a second input from the input receiving device of the electronic vaporizer device;
determining a second output mode of the plurality of output modes based on the second input, wherein a duration of time in which voltage output between the first electrical contact and the second electrical contact is different for at least two output modes of the plurality of output modes; and
providing the first voltage between the first electrical contact and the second electrical contact of the electronic vaporizer device for a duration of time based on the second output mode, wherein the duration of time in which voltage output between the first electrical contact and the second electrical contact in the second output mode is longer than the duration of time in which voltage is output between the first electrical contact and the second electrical contact in the first output mode.

12. The method for activating the electronic vaporizer device according to claim 10, further comprising:
receiving a second input from the input receiving device of the electronic vaporizer device;
determining a second output mode of a plurality of output modes based on the second input, wherein voltage between the first electrical contact and the second electrical contact is different for at least two output modes of the plurality of output modes; and
providing a second voltage between the first electrical contact and the second electrical contact of the electronic vaporizer device, wherein the second voltage is based on the second output mode.

13. The method for activating the electronic vaporizer device according to claim 10, further comprising:
receiving an indication that an activation element has been engaged;
based on the indication, providing the first voltage between the first electrical contact and the second electrical contact of the electronic vaporizer device, wherein the first voltage is based on the first voltage output mode.

14. The method for activating the electronic vaporizer device according to claim 10, further comprising:
receiving sensor input from a sensor and providing the first voltage between the first electrical contact and the second electrical contact of the electronic vaporizer device based on the received sensor input, wherein the first voltage is based on the first output mode.

15. The method for activating the electronic vaporizer device according to claim 14, wherein the sensor is at least one of a pressure transducer that detects a pressure drop or a microphone that detects a movement of air.

16. The method for activating the electronic vaporizer device according to claim 10, further comprising:
applying the first voltage to a heating element of a at least one of an atomizer, cartomizer, or clearomizer.

17. The method for activating the electronic vaporizer device according to claim 10, further comprising:
illuminating at least one status indicator based on the output mode.

18. The method for activating the electronic vaporizer device according to claim 17, further comprising:
illuminating the at least one status based on an amount of charge in a battery disposed within the electronic vaporizer device.

19. The method for activating the electronic vaporizer device according to claim 10, wherein the electronic vaporizer device includes a stylus tip covering the input receiving device, wherein the stylus tip is configured to work with at le

[symbol]

20. A method for activating an electronic vaporizer device for vaporizing inhalants, the method comprising:
receiving sensor input from a sensor and activating a first voltage output mode in accordance with the received sensor input;
providing a first voltage between a first electrical contact and a second electrical contact of the electronic vaporizer device, wherein the first voltage is based on the first voltage output mode;
receiving input from an input receiving device of the electronic vaporizer;
altering a voltage output mode from the first voltage output to a second voltage output mode;
receiving an indication that an activation element has been engaged; and
based on the indication, providing a second voltage between the first electrical contact and the second electrical contact of the electronic vaporizer device, wherein the second voltage is based on the second voltage output mode.
